(19) United States
(12) Patent Application Publication
(10) Pub. No.: US 2012/0206813 A1
(43) Pub. Date: Aug. 16, 2012

(54) TUNABLE SPECTRAL FILTER COMPRISING FABRY-PEROT INTERFEROMETER

(75) Inventors: Naveh Bahat, Rishon Le Zion (IL); Renald Leykin, Rehovot (IL); Raviv Erlich, Rehovot (IL)

(73) Assignee: ELBIT SYSTEM ELECTRO-OPTICS ELOP LTD., Rehovot (IL)

(21) Appl. No.: 13/503,372

(22) PCT Filed: Oct. 24, 2010
(86) PCT No.: PCT/IL10/00955

§ 371 Date: Apr. 23, 2012

(30) Foreign Application Priority Data
Oct. 25, 2009 (IL) 201742

(51) Int. Cl. G02B 5/28

(52) U.S. Cl. 359/578

(57) ABSTRACT

Tunable spectral filter includes a Fabry-Pérot interferometer (FPI), at least three actuators, at least three respective spring elements, and at least three respective sensors. The FPI includes two optical elements each having a partially reflective surface, with an optical cavity defining an optical gap between the two surfaces. The actuators, spring elements and sensors are disposed along the periphery of the optical elements. Multi-wavelength incident light enters the first optical element toward the optical cavity. Each actuator applies a selective force to move the optical element surfaces relative to each other, as the respective spring element applies an opposing force, thereby establishing an optical gap width, while maintaining the optical element surfaces substantially in parallel. Each sensor continuously detects the optical gap width and the planar parallelism, and provides a feedback signal to the actuators to apply selective forces to adjust the optical gap width or planar parallelism, if necessary.

### FIELD OF THE DISCLOSED TECHNIQUE

The disclosed technique relates to Fabry-Pérot interferometers, in general, and to a tunable spectral filter based on Fabry-Pérot interferometers, in particular.

### BACKGROUND OF THE DISCLOSED TECHNIQUE

A Fabry-Pérot interferometer (FPI), also known as a Fabry-Pérot resonator, is a resonant cavity made up of two parallel partially transparent mirrors. Incident light entering the cavity is reflected several times between the surfaces of the two mirrors, resulting in multiple offset beams which undergo constructive and destructive interference. A portion of the light is transmitted after each reflection. The wavelength of the transmitted light is dependent on the type of interference within the cavity, which in turn is a function of the separation distance between the two mirrors. Therefore, the transmission wavelength of the FPI can be altered by moving one mirror relative to the other.

Reference is now made to FIG. 1A, which is a schematic illustration of a Fabry-Pérot interferometer, generally referenced 10, which is known in the art. Fabry-Pérot interferometer (FPI) 10 includes a fixed mirror 12 and a moveable mirror 14, arranged in parallel. Mirrors 12 and 14 each have a conductive and reflective coating, and are separated by a medium, such as air or gas. A broad spectrum input light beam that includes a plurality of wavelengths λ₁ . . . λₙ undergoes multiple reflections within the cavity between mirrors 12 and 14. The reflected beams interfere with each other. Constructive interference occurs when the beams are in phase, and destructive interference takes place when the beams are out of phase. Whether the beams are in phase is a function of the optical gap width, i.e., the separation distance between the two mirrors, as well as the light wavelength, the angle at which the light is incident on the mirror, and the refractive index of the separation medium. For example, if the optical gap width d=λ/2, then all wavelengths that are not an integer multiple of λ/2 will produce destructive interference, and will not be transmitted by FPI 10. The wavelength of the transmitted light beam is therefore λᵢ, where “i” is an integer (i.e., all integer multiple of λ). For example, if the optical gap width is 150 nm, then the transmitted wavelengths would be 75 nm and 300 nm. Reference is now made to FIG. 1B, which is a schematic illustration of a graph, generally referenced 20, depicting the output spectrum of the Fabry-Pérot interferometer of FIG. 1A.

A standard use for an FPI is as a narrow bandwidth optical filter. In particular, such an optical filter may be part of a hyperspectral imager, which captures wide bands of the light spectrum for imaging. By collecting light in various parts of the spectrum, the hyperspectral imager obtains additional information pertaining to the imaged object, which would not otherwise be obtained via regular imaging. Many objects produce a unique spectral signature in different spectral bands, and therefore it is possible to identify these objects with a high degree of accuracy by collecting these unique signatures. Hyperspectral imaging is widely implemented in military surveillance, both aerial and terrestrial, for identifying various military targets, and also in general security surveillance applications. For example, it is possible to isolate live plants or foliage in a forested area in order to identify camouflaged targets, or to identify an explosive device or chemical weapon based on its spectral signature. Hyperspectral imaging also has many applications in other fields, ranging from geology and mineralogy (for identifying various minerals) to agriculture (for monitoring the development of various crops).

An FPI-based optical filter generally includes a mechanism for adjusting the optical gap width, typically with some form of actuator. Common types of actuators include electrostatic actuators (e.g., using capacitors), piezoelectric actuators, and magnetic actuators. Depending on the arrangement and placement, the adjustment mechanism may sometimes obstruct the region in the filter through which light must pass, diminishing the effectiveness of the filter. To overcome this problem, the mechanism may be affixed to the edges of the mirrors, limiting the obstructed area to the periphery and enabling light to pass through the center. However, such a layout can lead to a variable optical gap width along the surface of the mirrors, as the mirror bends to a greater degree in the center (where no mechanism is present) relative to the edges (where the mechanisms are located). To prevent distortions, it is necessary to have a high degree of consistency throughout the entire surface of the FPI.

Reference is now made to FIG. 2, which is a schematic illustration of an FPI, generally referenced 30, having a non-uniform optical gap width, which is known in the art. FPI 30 includes a fixed mirror 32 and a moveable mirror 34, supported by a pair of springs 36A and 36B at the edges. Springs 36A and 36B are typically thin pieces of silicon strips, which provide flexibility in the required area. A force is applied uniformly to mirror 34 via an actuator (not shown), in order to move mirror 34 relative to mirror 32 and change the optical gap width of FPI 30. Since springs 36A and 36B support the edges of mirror 34, mirror 34 caves in toward the center, resulting in an optical gap width at the center of FPI 30 (d_{center}) which is substantially smaller than the optical gap width at the edge of FPI 30 (d_{edge}). Although it is possible to minimize the mirror deformation by reducing the size of the mirrors, this would also serve to increase the portion of the area which is blocked, limiting the amount of light passing through.

U.S. Pat. No. 4,097,818 to Manoukian et al, entitled “Adjustable etalon laser mode selector and method of adjustment”, is directed to an adjustable Fabry-Pérot etalon mounted within a laser cavity for selecting a single mode of the laser output operational wavelength. The etalon includes a pair of prisms, spaced apart and centered along the optical axis of the laser cavity. The outer surface of each prism is inclined at a slight angle relative to the normal of the optical axis, to prevent the coupling of laser energy back into the laser cavity. The inner surface of each prism is inclined at an angle relative to the optical axis, which is the Brewster angle at the nominal laser wavelength, to eliminate the need for anti-reflective coating on these surfaces. A piezoelectric member having electrically conductive surfaces is affixed to one of the prisms. The spacing between the prisms is adjusted by applying a varying electric potential to the piezoelectric member. The adjustment involves translating a prism longitudinally along a line coplanar with the optical axis of the laser cavity, and at an angle of about 45° to the inner surface of the prism. Such a translation ensures that the overall laser cavity optical path length is constant (while the optical path length through the prism material of the etalon, in the air space between the two prisms, and in the laser cavity external to the etalon, may be varied), and thus the natural resonant frequency of the laser cavity remains unchanged.

U.S. Pat. No. 6,836,366 to Flanders et al, entitled “Integrated tunable Fabry-Pérot filter and method of making same”, is directed to a tunable Fabry-Pérot filter (FPF). The FPF includes a movable reflector, a fixed concave-shaped reflector, and a pair of electrodes. The spacing between the reflectors defines an optical cavity. The spacing between the electrodes and the movable reflector defines an electrostatic cavity. A voltage is applied across the electrostatic cavity, to deflect the movable reflector and alter the length of the optical cavity, thereby tuning the filter wavelength. The movable reflector is formed as a movable membrane having an inner membrane portion connected to an outer body portion by a pattern of flexures. The flexures may be shaped in different patterns, (e.g., straight, radial, spiral), to provide a desired amount of deflection of the membrane for expected voltage ranges and optical operational characteristics. The FPF may be an integrated structure fabricated using semiconductor device fabrication and photolithographic techniques. For example, the optical cavity may be designed as a semiconductor layer (e.g., silicon layer) and an oxide layer, the thickness of which is used to control the cavity length.

U.S. Pat. No. 6,915,048 to Kersey et al, entitled “Fabry-Pérot filter/resonator”, is directed to a tunable Fabry-Pérot optical device, which may function as a filter, with a non-optical closed-loop control configuration. The device includes an optical waveguide having a core region containing optical fibers aligned along a longitudinal axis and separated by an air gap. The waveguide may be a cane waveguide in a dogbone structure, with wide end portions separated by a narrower intermediate portion, thereby providing a larger stress in the intermediate portion from applied forces. The air gap may be formed by etching a portion of the waveguide. An actuator, such as a piezoelectric transducer (PZT), is used to alter the gap width of the Fabry-Pérot element, by applying a compression/tension axial force to a movable block adjoining an end of the element within a housing. A displacement sensor detects the precise gap width via capacitive elements mounted on each end of the Fabry-Pérot element. A controller receives a wavelength input signal, representing the desired resonant wavelength to output from the optical device, and receives a sensed signal from the displacement sensor, representing the current gap width. The controller sends a control signal to the actuator to alter the force applied to the Fabry-Pérot element, in order to achieve the necessary gap width associated with the desired resonant wavelength.

U.S. Pat. No. 7,242,482 to Brown et al, entitled “Capacitance gap calibration”, is directed to a method for calibrating a display device, containing an array of microelectromechanical systems (MEMS) configured to act as tunable Fabry-Pérot interferometers (FPIs). Each FPI pixel includes a MEMS capacitor having a top reflective plate and a bottom reflective plate, with an optical gap therebetween. The top reflective plate includes spring-like flexure regions at each end. A pull-up switch and a pull-down switch connect the top plate to a supply voltage. When white light is incident on the pixel, the color of light reflected from the pixel is determined by the width of the optical gap. The gap width is controlled by applying a voltage to the capacitor, which creates an electrostatic force between the reflective plates, pulling the plates together. The top reflective plate may include a transparent stiffer mounted on its surface, to ensure bending of the plate primarily at the flexure regions. The electrostatic force is counterbalanced by a spring force from the flexure regions, resulting in a stable optical gap, represented by the capacitance between the plates. A switched capacitor technique is used to measure the gap capacitance, which changes over time due to a gradual change in the spring constant of the flexure regions. In particular, the capacitance is determined based on a measured average current, a known applied voltage, and a known capacitor switching frequency. If the relationship between the applied voltage and the gap capacitance has changed, the applied voltage to achieve a particular color output is adjusted accordingly.

US Patent Application Publication No. 2002/0015215 to Miles, entitled “Interferometric modulation of radiation”, is directed to a interferometric modulator (IMod), which includes a moveable membrane connected to the substrate by support posts via tethers. The tethers are arranged in a pinwheel configuration, which allows the movable membrane to rotate clockwise or counterclockwise in a fixed plane, in order to relieve residual stress in the membrane. The movable membrane contains a damping hole, for reducing the force required to displace the air as the membrane is moving, thereby limiting the damping effect and the response time of the IMod. In general, the IMod response time is controlled by the lengths and thickness of the tethers, the presence and dimensions of the damping holes, and the ambient gas pressure in the vicinity of the IMod. The IMod may include three parallel walls (two movable membranes and a substrate), capable of being in three distinct states (e.g., corresponding to different colors) depending on the relative gaps between each of the walls. Each membrane may include dielectric, metallic or semiconducting films. The IMod may be fabricated as a MEMS, where a wall of the IMod is formed on the substrate and a gas phase etchant is used to remove a deposited sacrificial layer from between the wall and the substrate.

US Patent Application Publication No. 2004/0218865 to Liang-Ju, entitled “Tunable Fabry-Perot filter”, is directed to a tunable Fabry-Perot filter (TFPF) that uses the hybrid integration of MEMS and micro-optics. The TFPF includes two reflecting surfaces attached to a MEMS displacement actuator, which define a Fabry-Perot filter. The reflecting surfaces are formed on opposite ends of two optical fibers. The actuator includes a rotational alignment mechanism, for rotationally aligning a reflecting surface at one fiber end with the reflecting surface at the other fiber end, and a displacement mechanism, for adjusting the separation distance between the reflecting surfaces. The actuator includes electrodes for actuating the rotational alignment mechanism and the displacement mechanism. The displacement mechanism is made up of a flexible member, which may be a beam member formed by two parallel slots, with a central aperture for permitting light to pass through the fibers. Application of voltage to the electrodes results in the beam member flexing or deforming in a manner which serves to increase or decrease the separation distance between the fiber ends, thereby changing the length of the FP cavity. The flexible member may have an alternate geometry, such as circular (which operates like a diaphragm). Each of the reflective surfaces may be planar, or may be flat or curved (i.e., concave or convex).

### SUMMARY OF THE DISCLOSED TECHNIQUE

In accordance with one aspect of the disclosed technique, there is thus provided a tunable spectral filter. The filter includes a Fabry-Pérot interferometer (FPI), at least three actuators, at least three spring elements respective of the actuators, and at least three sensors respective of the actuators and spring elements. The FPI includes a first optical element having a partially reflective surface, and a second optical element having a partially reflective surface facing the partially reflective surface of the first optical element, with an optical cavity defining an optical gap between the two surfaces. The actuators are disposed along the periphery of at least one of the first optical element and the second optical element. The spring elements are disposed along the periphery of at least one of the first optical element and the second optical element. The sensors are disposed along the periphery of at least one of the first optical element and the second optical element. Multi-wavelength incident light enters the first optical element toward the optical cavity. Each actuator applies a selective force to move the surface of the first optical element relative to the surface of the second optical element. Each spring element applies an opposing force against the selective force applied by the respective actuator, thereby establishing an optical gap width of the optical gap, while maintaining the first optical element surface and the second optical element surface substantially in parallel. Each sensor continuously detects the optical gap width and the planar parallelism between the first optical element surface and the second optical element surface, and provides a feedback signal to the actuators to apply selective forces to adjust the optical gap width or planar parallelism, if necessary. The tunable spectral filter may be used as a detection element for a hyperspectral imaging device.

In accordance with the disclosed technique, there is further provided a method for tunable spectral filtering. The method includes the procedure of directing incident multi-wavelength light toward a Fabry-Pérot interferometer (FPI) having an optical cavity defining an optical gap between the partially reflective surface of a first optical element and the partially reflective surface of a second optical element. The method further includes the procedure of applying selective forces to move the first optical element relative to the second optical element, to establish an optical gap width of the optical gap, while maintaining the first optical element surface and the second optical element surface substantially in parallel, using at least three actuators and respective spring elements disposed along the periphery of at least one of the first optical element and the second optical element. The method further includes the procedures of continuously detecting the optical gap width and planar parallelism between the first optical element surface and the second optical element surface, using at least three sensors respective of the actuators and spring elements, disposed along the periphery of at least one of the first optical element and the second optical element, and sending a feedback signal to the actuators to adjust the optical gap width or planar parallelism if necessary. The method further includes the procedure of providing outgoing light at a selected wavelength from the FPI, the selected wavelength adjustable in accordance with the optical gap width.

### BRIEF DESCRIPTION OF THE DRAWINGS

The disclosed technique will be understood and appreciated more fully from the following detailed description taken in conjunction with the drawings in which:

FIG. 1A is a schematic illustration of a Fabry-Pérot interferometer, which is known in the art;

FIG. 1B is a schematic illustration of a graph depicting the output spectrum of the Fabry-Pérot interferometer of FIG. 1A;

FIG. 2 is a schematic illustration of a Fabry-Pérot interferometer having a non-uniform optical gap width, which is known in the art;

FIG. 3A is a top perspective cross-sectional view illustration of a Fabry-Pérot interferometer (FPI) based tunable spectral filter, constructed and operative in accordance with an embodiment of the disclosed technique;

FIG. 3B is a side elevation cross-sectional view illustration of the tunable spectral filter of FIG. 3A;

FIG. 3C is a bottom perspective view illustration of the tunable spectral filter of FIG. 3A;

FIG. 3D is an exploded view illustration of the tunable spectral filter of FIG. 3A;

FIG. 3E is a bottom surface view illustration of the tunable spectral filter of FIG. 3A;

FIG. 4 is a side view illustration of the tunable spectral filter of FIG. 3A having a uniform optical gap width; and

FIG. 5 is a block diagram of a method for filtering light with an FPI-based tunable spectral filter, operative in accordance with an embodiment of the disclosed technique.

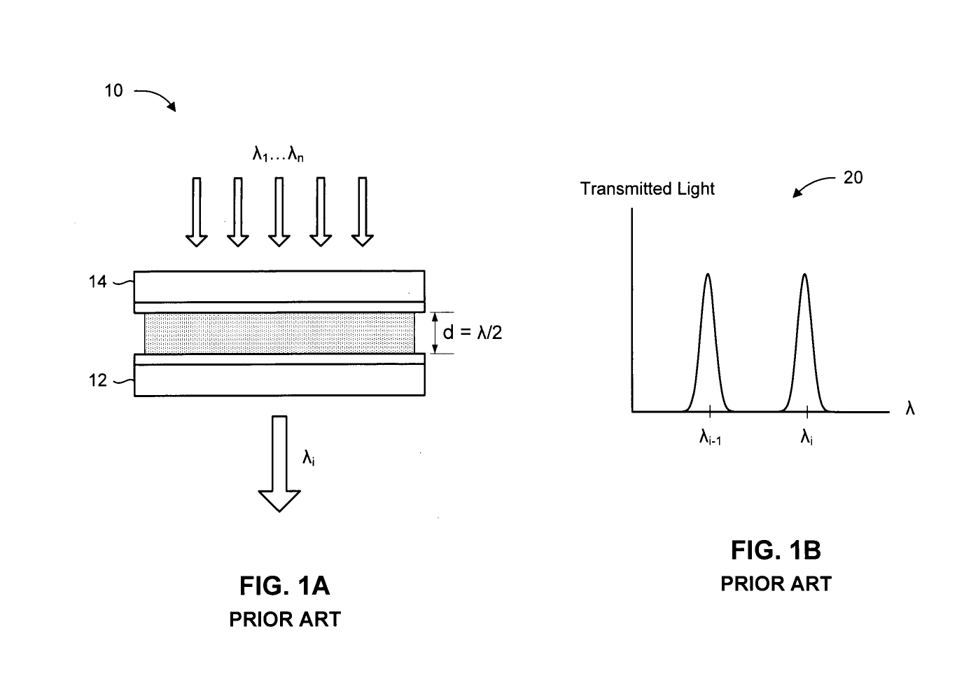

### DETAILED DESCRIPTION OF THE EMBODIMENTS

The disclosed technique overcomes the disadvantages of the prior art by providing a tunable spectral filter made up of a Fabry-Pérot interferometer (FPI) and at least three adjustment mechanisms disposed along the periphery of the mirrors. The adjustment mechanisms include actuators and spring elements which adjust the optical gap width of the Fabry-Pérot cavity, to establish the wavelength of the light exiting the spectral filter, while maintaining the mirror surfaces substantially parallel to one another, to minimize distortions resulting from a non-uniform optical gap width. The adjustment mechanisms also include sensors which detect the current optical gap width and planar parallelism of the mirror surfaces, and supply a feedback signal for the actuators to adjust the applied force, thereby providing tuning and calibration of the spectral filter.

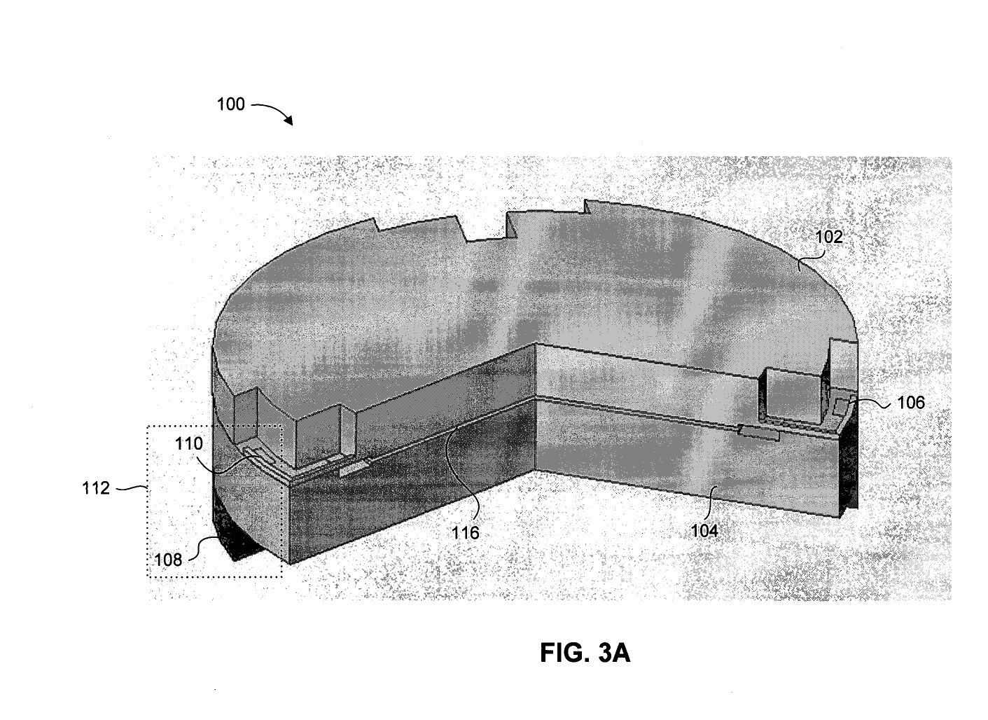

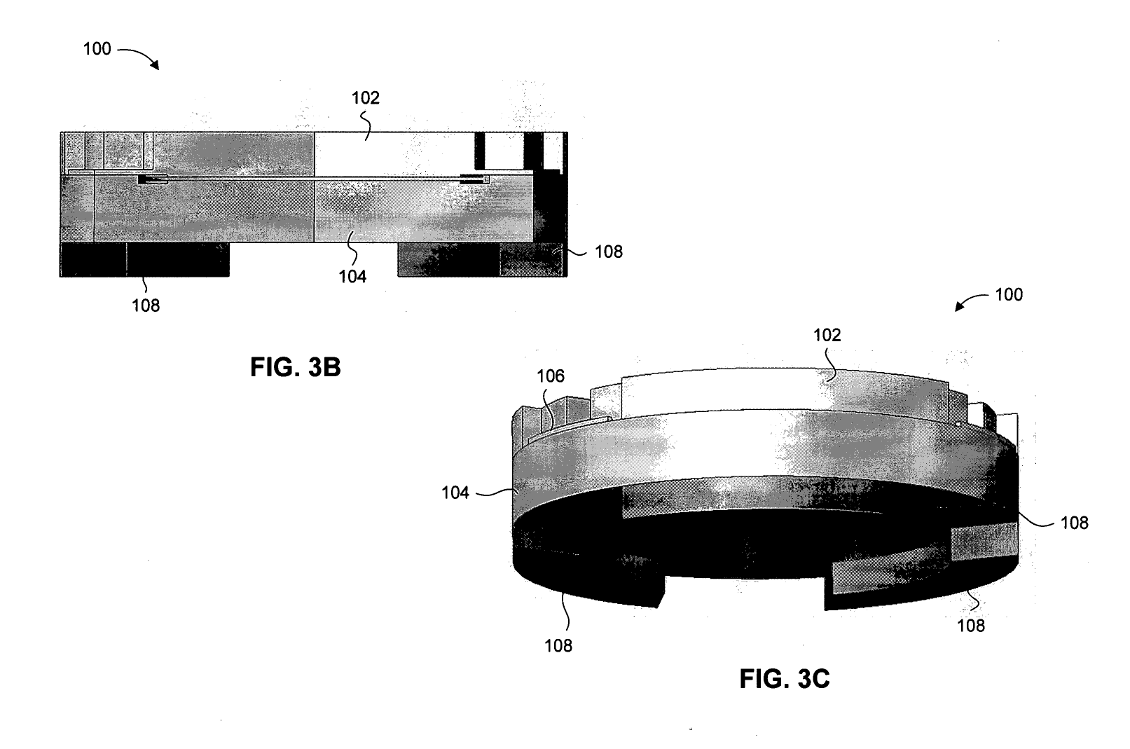

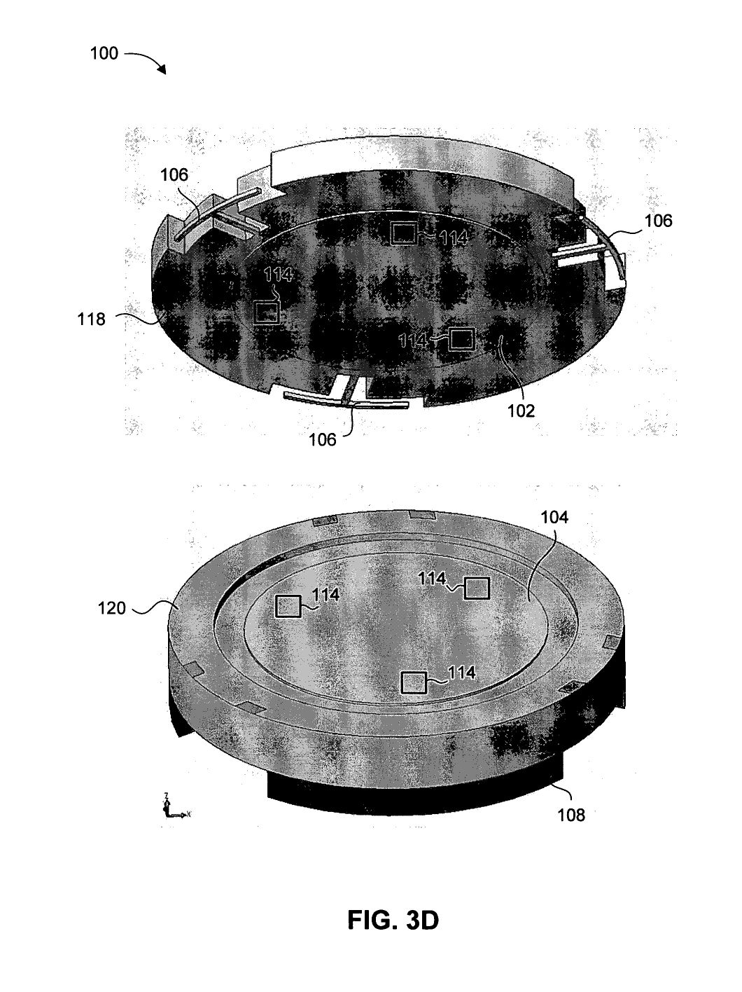

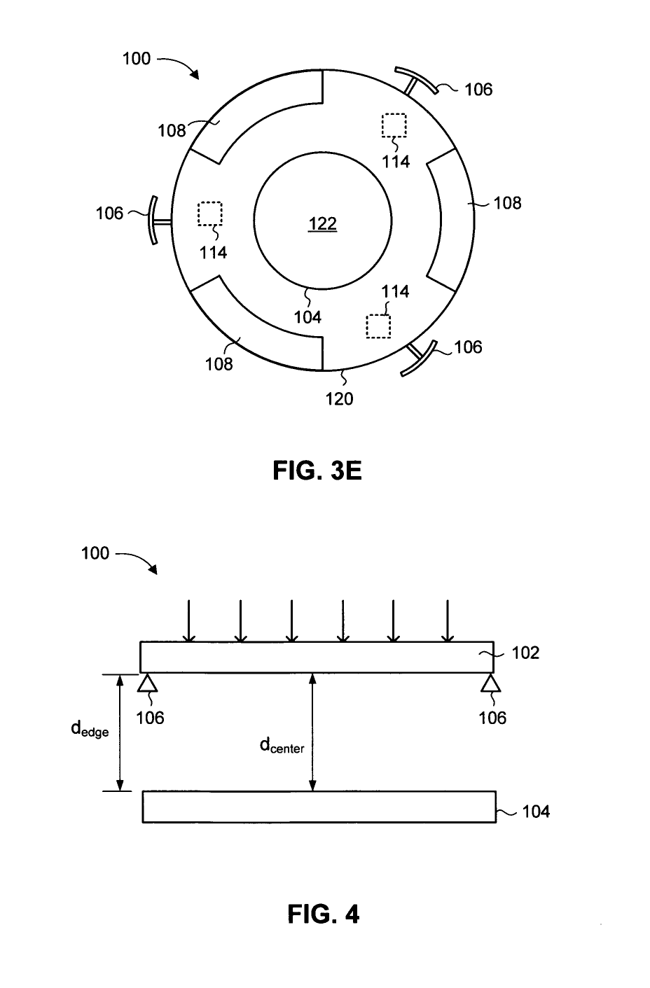

Reference is now made to FIGS. 3A, 3B, 3C, 3D and 3E. FIG. 3A is a top perspective cross-sectional view illustration of a Fabry-Pérot interferometer (FPI) based tunable spectral filter, generally referenced 100, constructed and operative in accordance with an embodiment of the disclosed technique. FIG. 3B is a side elevation cross-sectional view illustration of the tunable spectral filter of FIG. 3A. FIG. 3C is a bottom perspective view illustration of the tunable spectral filter of FIG. 3A. FIG. 3D is an exploded view illustration of the tunable spectral filter of FIG. 3A. FIG. 3E is a bottom surface view illustration of the tunable spectral filter of FIG. 3A. Spectral filter 100 includes a first mirror 102, a second mirror 104, three spring elements 106, three actuators 112, and three sensors 114. Each actuator 112 includes a magnet 108 disposed on one side of mirror 104 and a coil 110 disposed on one side of mirror 102. Alternatively, magnet 108 may be disposed on mirror 102, and coil 110 disposed on mirror 104. Accordingly, actuators 112 are preferably electromagnetic actuators, although other types of actuators (e.g., electrostatic actuators, piezoelectric actuators) may also be used in accordance with the disclosed technique. Actuators 112 are disposed along the periphery of the mirrors, preferably equidistantly spaced. Sensors 114 are preferably parallel-plate capacitors, in which the capacitance is inversely proportional to the separation distance between the two plates. One of the capacitor plates is disposed on the bottom surface of the top mirror 102, facing the corresponding capacitor plate which is disposed on the top surface of the bottom mirror 104 (FIGS. 3D and 3E), allowing for the separation distance between the two mirror surfaces to be calculated. Sensors 114 are preferably equidistantly spaced along the periphery of the mirrors. A respective actuator 112 together with a respective spring element 106 and a respective sensor 114 makes up an adjustment mechanism (i.e., spectral filter 100 includes three adjustment mechanisms, where each adjustment mechanism includes a magnet 108, a coil 110, a spring element 106, and a sensor 114). It is appreciated that spectral filter 100 generally includes at least three adjustment mechanisms, and in a preferred embodiment includes exactly three.

First mirror 102 and second mirror 104 each have a partially reflective surface. Mirrors 102 and 104 are aligned such that their respective partially reflective surfaces are optically coupled with and facing one another. The surfaces of mirrors 102 and 104 are separated by an optical gap 116, defining a Fabry-Pérot cavity between them. In general, mirrors 102 and 104 may be any optical element that provides the necessary reflection and transmission of light, such as an optical waveguide, a lens or a prism with a reflective coating, and the like. The reflectivity of the surfaces of mirrors 102 and 104 can be achieved with a reflective coating (e.g., silver coating, aluminum coating, and the like). In the embodiment of FIGS. 3A, 3B, 3C, 3D and 3E, mirrors 102 and 104 are circular, but it is appreciated that mirrors 102 and 104 may alternatively be a different shape. Optical gap 116 is generally composed of air, but may be another medium through which light may pass through.

Mirrors 102 and 104 are enclosed within a housing or frame. In particular, the edges of mirror 102 are enclosed by a first housing 118 (i.e. the surfaces of mirror 102 remain exposed). Similarly, the edges of mirror 104 are enclosed by a second housing 120. Spring elements 106 (FIGS. 3D and 3E) are disposed along the edges of housing 118, jutting outwards. Spring elements 106 may be a thin piece of silicon, or another material that provides flexibility and support. Spectral filter 100 generally includes at least three spring elements 106, and in a preferred embodiment includes exactly three, which are preferably spaced out equidistantly along the outer perimeter of mirror 102.

Incident light is reflected within the cavity between mirrors 102 and 104, and light of a particular wavelength is transmitted from spectral filter 100, in accordance with the principles of a Fabry-Pérot interferometer, as known in the art. Actuators 112 and spring elements 106 are operative to adjust the width of optical gap 116 to provide the desired outgoing wavelength, by moving mirror 104 relative to mirror 102. Each actuator 112 applies an electromagnetic force which pushes or pulls mirror 104 (i.e. toward or away from mirror 102), while the respective spring element 106 provides a resilient opposing mechanical force, thereby maintaining the spacing (optical gap width) between mirrors 102 and 104. The equilibrium between the electromagnetic force from actuators 112 and the mechanical force from spring elements 106 determines the positive location of mirrors 102 and 104 (and correspondingly, the optical gap width). It is noted that mirror 104 may be moveable and mirror 102 fixed, or alternatively, mirror 102 may be moveable and mirror 104 fixed, or further alternatively, both mirrors 102 and 104 may be moveable.

The adjustment mechanisms are further operative for continuous calibration of spectral filter 100. In particular, sensors 114 detect the current optical gap width of spectral filter 100 and provide a feedback signal to actuators 112, which if necessary, apply the required forces in order to adjust the optical gap width (and correspondingly the outgoing wavelength) to the desired value. Sensors 114 further detect the level of planar parallelism between the surfaces of mirrors 102 and 104, and provide a feedback signal to actuators 112, which if necessary, apply the required forces in order to maintain the two mirrors substantially parallel (i.e., such that the optical gap width is consistent along the entirety of the mirrors), to minimize any distortions or errors that may result due to a non-uniform optical gap width. The level of parallelism between the mirrors corresponds to the spectral shape of the outgoing light. Spectral filter 100 may further include a processor or controller (not shown), which controls the feedback signals and the operation of actuators 112 and sensors 114.

It is noted that each adjustment mechanism (i.e., actuator 112 and sensor 114) preferably operates independently of the others, providing efficient tuning and calibration of spectral filter 100. Since the three actuators 112 define a plane along the surface of mirror 104 (as any three points define a plane in space), each actuator 112 may apply a different force to mirror 104 (against the spring force of the respective spring element 106) to provide the required optical gap width with a high degree of accuracy, while ensuring that surfaces of mirrors 102 and 104 are substantially parallel to a high degree of accuracy.

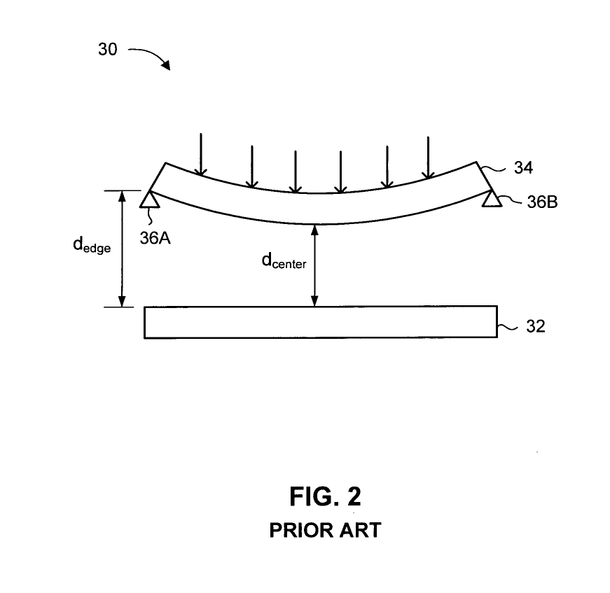

Reference is now made to FIG. 4, which is a side view illustration of the tunable spectral filter of FIG. 3A having a uniform optical gap. Each actuator 112 (not shown) applies a selective force to mirror 104, in order to move mirror 104 relative to mirror 102 and change the optical gap width of spectral filter 100. Since the three spring elements 106 (two of which are shown) together with the three actuators 112 define a plane, mirror 102 does not cave in toward the center (similar to FPI 30 of FIG. 2). Rather, the optical gap width at the center of spectral filter 100 (d_{center}) is substantially equal to the optical gap width at the edge of spectral filter 100 (d_{edge}). Each actuator 112 applies the appropriate level of force to maintain parallel alignment and a uniform optical gap width across the surface of mirrors 102 and 104.

Referring back to FIG. 3E, sensors 114 also perform an initial calibration of spectral filter 100, in order to align mirrors 102 and 104 substantially in parallel prior to the initial operation, as generally the mirrors are not parallel following their manufacturing. Subsequently, during the operational stage an additional calibration process is carried out in order to align the mirrors in parallel while adjusting the optical gap width, as described hereinabove. Each sensor 114 detects the precise optical gap width at a fixed location along the surface of the mirrors. In accordance with the detected values, each actuator 112 applies a force to adjust the optical gap width at a specific point, until the mirrors 102 and 104 are substantially parallel. Each sector or region of the mirror may require a different amount of adjustment. The calibration process may utilize a calibration table, which includes the required calibration for different possible optical gap widths. For example, the calibration table may be a look-up table (LUT) that takes into account additional factors that affect the optical gap width, such as temperature, spring type and the like. The calibration is typically performed after the manufacturing stage and during the initial operational stage. It is also possible to enable the operator of spectral filter 100 to perform a calibration at his discretion.

The configuration of the various elements of spectral filter 100 results in a large central aperture 122 (FIG. 3E) through mirrors 102 and 104. Consequently, light may pass through the center of spectral filter 100 without any obstructing elements, thereby improving the overall effectiveness of the filter. It is appreciated that the peripheral architecture of the mechanisms in accordance with the disclosed technique enables both an unobstructed light path and a uniform optical gap width after mirror adjustment.

Spectral filter 100 is preferably fabricated using microelectromechanical system (MEMS) technology. Mirrors 102 and 104 (and the associated housings 118 and 120) are typically composed of silicon, which transmits light in the spectral range of approximately 1.2-2.5 μm. Alternatively, mirrors 102 and 104 may include a layer of glass (or another optical element) optically coupled with a layer of silicon, so that the light propagates through a glass medium (rather than silicon), allowing for the filtering of other wavelengths. It is noted that the use of electromagnetic actuators 112 allows for the varying of the size of magnets 108, and thus varying the strength of the applied electromagnetic force accordingly, thereby increasing the operational spectral range of spectral filter 100 and allowing spectral filter 100 to operate in various environmental conditions.

Spectral filter 100 may be used a detection element, such as a sensor for a hyperspectral imaging device. Such a sensor may be composed of multiple detection elements (e.g., an array) of spectral filter 100.

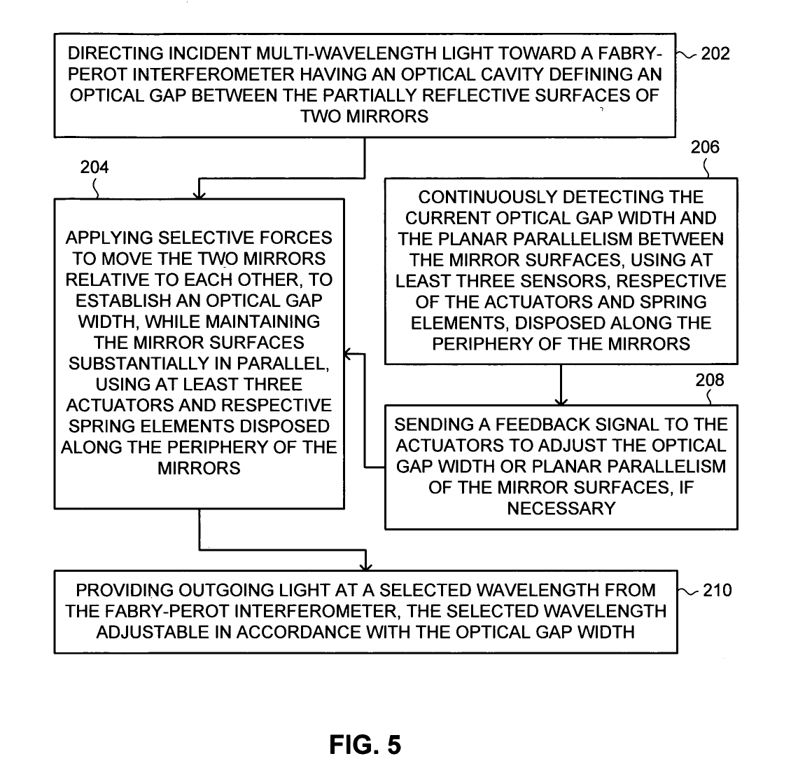

Reference is now made to FIG. 5, which is a block diagram of a method for filtering light with an FPI-based tunable spectral filter, operative in accordance with an embodiment of the disclosed technique. In procedure 202, multi-wavelength incident light is directed toward a Fabry-Pérot interferometer having an optical cavity defining an optical gap between the partially reflective surfaces of two mirrors. With reference to FIG. 3A, multi-spectral incident light enters the Fabry-Pérot cavity between mirrors 102 and 104 of spectral filter 100.

In procedure 204, selective forces are applied to move the two mirrors relative to each other, to establish an optical gap width, while maintaining the mirror surfaces substantially in parallel, using at least three actuators and respective spring elements disposed along the periphery of the mirrors. With reference to FIGS. 3A, 3B, 3C, 3D and 3E, each actuator 112 applies a selective electromagnetic force to move mirror 104 relative to mirror 102, the location of the mirrors 102 and 104 determined by the equilibrium between the electromagnetic force from actuators 112 and the opposing mechanical force from the respective spring elements 106, thereby establishing the optical gap width (i.e., the separation distance between mirrors 102 and 104) of the Fabry-Pérot cavity. The mirrors 102 and 104 are maintained in parallel alignment, such that the optical gap width is uniform throughout the entirety of the mirror surfaces.

In procedure 206, the current optical gap width and the planar parallelism between the mirror surfaces is continuously detected, using at least three sensors, respective of the actuators and the spring elements, disposed along the periphery of the mirrors. With reference to FIG. 3E, sensors 114 detect the current optical gap width of spectral filter 100, and further detect the level of planar parallelism between the surfaces of mirrors 102 and 104.

In procedure 208, a feedback signal is sent to the actuators to adjust the optical gap width or the planar parallelism of the mirror surfaces, if necessary. With reference to FIG. 3E, sensors 114 provide feedback signals to actuators 112, to apply the required forces to adjust the optical gap width or to adjust the level of planar parallelism between the surfaces of mirrors 102 and 104, if necessary.

In procedure 210, outgoing light at a selected wavelength is provided from the Fabry-Pérot interferometer, the selected wavelength being adjustable in accordance with the optical gap width. With reference to FIGS. 3A, 3B, 3C, 3D and 3E, outgoing light at a selected wavelength exits spectral filter 100 via mirror 104, after undergoing reflections in the Fabry-Pérot cavity. The selected wavelength is a function of the optical gap width, which is adjusted with the adjustment mechanisms (actuators 112, spring elements 106 and sensors 114) of spectral filter 100.

It will be appreciated by persons skilled in the art that the disclosed technique is not limited to what has been particularly shown and described hereinabove.

1. A tunable spectral filter comprising:
a Fabry-Pérot interferometer (FPI), operative to filter a selected wavelength of multi-wavelength incident light, said FPI comprising:
a first optical element, having a partially reflective surface, said incident light entering said first optical element; and
a second optical element, having a partially reflective surface facing said partially reflective surface of said first optical element, defining an optical gap therebetween, outgoing light at said selected wavelength exiting said second optical element, said selected wavelength determined in accordance with the optical gap width of said optical gap;
three actuators, disposed along the periphery of at least one of said first optical element and said second optical element, each of said actuators operative to apply a selective force against at least one of said first optical element and said second optical element, to move said first optical element surface relative to said second optical element surface;
at least three spring elements, respective of said actuators, said spring elements disposed along the periphery of at least one of said first optical element and said second optical element, each of said spring elements operative to apply an opposing force against said selective force applied by said respective actuator, thereby establishing said optical gap width while maintaining said first optical element surface and said second optical element surface substantially in parallel; and
three sensors, respective of said actuators and said spring elements, said sensors disposed along the periphery of at least one of said first optical element and said second optical element, each of said sensors operative to continuously detect said optical gap width and the planar parallelism between said first optical element surface and said second optical element surface, and to provide a feedback signal to said actuators to apply selective forces to adjust said optical gap width or said planar parallelism, if necessary.

2. The spectral filter according to claim 1, wherein said actuators are electromagnetic.

3. The spectral filter according to claim 2, wherein each of said actuators comprises:
a magnet disposed on one of said first optical element and said second optical element; and
a coil disposed on the other of said first optical element and said second element.

4. The spectral filter according to claim 1, wherein said actuators, said spring elements, and said sensors, are disposed substantially equidistant along the periphery of said first optical element and said second optical element.

5. The spectral filter according to claim 1, wherein said actuators, said spring elements, and said sensors are disposed outside the optical path of said incident light and said outgoing light.

6. The spectral filter according to claim 1, wherein either of said first optical element and said second optical element is selected from the list consisting of:
a mirror;
a lens; and
a waveguide.

7. The spectral filter according to claim 1, wherein one of said first optical element and said second optical element is fixed, and wherein said actuators are operative to move the other one of said first optical element and said second optical element.

8. The spectral filter according to claim 1, further comprising a controller, coupled with said actuators and said sensors, said controller operative to control the operation of said actuators and said sensors.

9. A hyperspectral imaging device comprising at least one tunable spectral filter comprising:
a Fabry-Pérot interferometer (FPI), operative to filter a selected wavelength of multi-wavelength incident light, said FPI comprising:
a first optical element, having a partially reflective surface, said incident light entering said first optical element; and
a second optical element, having a partially reflective surface facing said partially reflective surface of said first optical element, defining an optical gap therebetween, outgoing light at said selected wavelength exiting said second optical element, said selected wavelength determined in accordance with the optical gap width of said optical gap;
three actuators, disposed along the periphery of at least one of said first optical element and said second optical element, each of said actuators operative to apply a selective force against at least one of said first optical element and said second optical element, to move said first optical element surface relative to said second optical element surface;
at least three spring elements, respective of said actuators, said spring elements disposed along the periphery of at least one of said first optical element and said second optical element, each of said spring elements operative to apply an opposing force against said selective force applied by said respective actuator, thereby establishing said optical gap width while maintaining said first optical element surface and said second optical element surface substantially in parallel; and
three sensors, respective of said actuators and said spring elements, said sensors disposed along the periphery of at least one of said first optical element and said second optical element, each of said sensors operative to continuously detect said optical gap width and the planar parallelism between said first optical element surface and said second optical element surface, and to provide a feedback signal to said actuators to apply selective forces to adjust said optical gap width or said planar parallelism, if necessary.

10. A method for tunable spectral filtering, said method comprising the procedures of:
directing incident multi-wavelength light toward a Fabry-Pérot interferometer (FPI) having an optical cavity defining an optical gap between the partially reflective surface of a first optical element and the partially reflective surface of a second optical element;
applying selective forces to move said first optical element relative to said second optical element, to establish an optical gap width of said optical gap, while maintaining said first optical element surface and said second optical element surface substantially in parallel, using three actuators and respective spring elements disposed along the periphery of at least one of said first optical element and said second optical element;
continuously detecting said optical gap width and the planar parallelism between said first optical element surface and said second optical element surface, using three sensors, respective of said actuators and said spring elements, disposed along the periphery of at least one of said first optical element and said second optical element;
sending a feedback signal to said actuators to adjust said optical gap width or said planar parallelism, if necessary; and
providing outgoing light at a selected wavelength from said FPI, said selected wavelength adjustable in accordance with said optical gap width.
